(19) United States
(12) Patent Application Publication
(10) Pub. No.: US 2005/0213689 A1
(43) Pub. Date: Sep. 29, 2005

(54) Demodulator circuit, radio communication system and communication semiconductor integrated circuit

(75) Inventors: Keisuke Matsuda, Kodaira (JP); Takashi Okubo, Sayama (JP); Toyokazu Hori, Kodaira (JP); Kazuyuki Takada, Kawaguchi (JP)

Correspondence Address: Stanley P. Fisher;Reed Smith Hazel & Thomas LLP, Suite 1400, 3110 Fairview Park Drive, Falls Church, VA, 22042-4503, US

(73) Assignee: Renesas Technology Corporation

(21) Appl. No.: 11/037,133

(22) Filed: Jan. 19, 2005

(30) Foreign Application Priority Data
Mar. 9, 2004 (JP) 2004-065567

(51) Int. Cl. H04L 27/14

(52) U.S. Cl. 375/324

(57) ABSTRACT

A communication semiconductor integrated circuit has a demodulator circuit built in a single semiconductor chip. The demodulator circuit is constructed to demodulate a received OFDM-modulated packet signal including a preamble that has two or more fixed-signal sequences, and to have a frequency-error estimating/correcting function that estimates the frequency error of the received signal by using the received preamble and corrects the received signal for the frequency error, a fast Fourier transform function (FFT portion 210) that converts the time-axis information of the corrected received signal to frequency-axis information, a transmission path response estimating/correcting function that estimates the status of the transmission path from the converted signal and corrects the received signal for the transmission path response, and an averaging function that averages the received signal after being corrected for the frequency error so that the averaging can be performed before the fast Fourier transform process.

### INCORPORATION BY REFERENCE

The present application claims priority from Japanese application JP2004-065567 filed on Mar. 9, 2004, the content of which is hereby incorporated by reference into this application.

### BACKGROUND OF THE INVENTION

The present invention relates to a modulator circuit and radio communication system using the OFDM (Orthogonal Frequency Division Multiplexing) modulation system, and particularly to a technique useful for shortening the receiving process delay.

There is now a modulation system using OFDM as one of the modulation systems for the transmitted signal in radio communication and digital broadcasting. Since the OFDM modulation system is a digital modulation system using a plurality of carriers that has orthogonality, it generally has excellent characteristics against multipath interference. However, since it causes a large signal distortion due to frequency error because of using a plurality of carriers, it is necessary to synchronize frequencies with high precision. In addition, in order to make good use of the excellent characteristics against the multipath interference, it is necessary to appropriately correct the response of transmission path (the receiving conditions that change according to the surrounding circumstances such as ghost) to each subcarrier.

Moreover, although the wireless LAN that employs the OFDM modulation system transmits data in a form of packets, it is necessary to fast make packet detection and synchronization process in the packet transmission. For this purpose, the OFDM packet signal generally has a signal formed of repeated known patterns, or a preamble signal (hereinafter, referred to simply as preamble) provided at the head of the packet, so that the packet detection, synchronization process and correction for transmission path response can be performed by using the preamble. As an example, FIG. 2 shows the format of the packet according to the rule, IEEE802.11a as the 5-GHz band wireless LAN standard.

As illustrated in FIG. 2, the IEEE802.11a packet has a short preamble SPA (t1˜t10), a long preamble LPA (T1, T2), a signal portion (SIGNAL), and data portion (DATA). The short preamble SPA of the format has ten repeated fixed-patterns of 0.8-μs duration each that are used mainly for detection of timing and for receiving-synchronization process. The long preamble LPA has two repeated fixed-patterns of 3.2-μs duration each. It also has, added at the head of the long preamble, a copy of the last 32 samples (1.6 μs) of the long preamble LPA as a guard interval GI to form the total length of 8 μs. This long preamble is used to correct for frequency error and correct transmission path response. The signal portion (SIGNAL) has a symbol containing the data transfer rate and data length of the following data portion (DATA). It also has, added at the head of the symbol, a copy of the last 16 samples (0.8 μs) of the symbol as a guard interval GI to form the total length of 4 μs. The data portion (DATA) also has, added at the head of the data portion (DATA), this GI to form the total length of 4 μs. A transmission path response estimating system associated with the radio communication signal having the packet format shown in FIG. 2 is disclosed in a document of “A study on Channel Estimation Technique in OFDM System” as a technical report of IEICE RCS 2000-34 (2000-06) issued by Institute of Electronics, Information and Communication Engineers, PP. 33-40.

### SUMMARY OF THE INVENTION

FIG. 1 is a block diagram showing the construction examined by the inventors before this invention of a demodulator circuit for demodulating an OFDM modulated-signal. FIG. 3 is a block diagram showing the details of a frequency error estimating/correcting portion 210 and an equalizer 230 in the demodulator circuit examined by the inventors before this invention. The packet received by an antenna 201 is converted down to a base band signal by an RF portion 202, and converted to a digital signal by an A/D converter 203. Subsequently, an FIR (Finite Impulse Response) filter 204 processes the received digital signal so that the out-of-band high-frequency components can be removed from the digital signal. An AGC (Auto Gain Control) 205 controls the gain of the RF portion 202 so that the level of the received signal can be held within the dynamic range of the A/D converter 203.

A synchronizing portion 206 has a synchronizing detector 207 that detects the synchronizing positions and makes the synchronizing process by use of the repeated patterns of the preamble of the received packet that has just been converted to a digital signal. It also has the frequency error estimating/correcting portion 210 that estimates a frequency error and corrects for the frequency error. At this time, the guard intervals are eliminated from the packet. An FFT (Fast Fourier Transform) portion 220 converts the received signal from the time-axis information to the frequency-axis information.

The equalizer 230 compares the received preamble pattern converted to the frequency-axis information and a known preamble pattern so as to estimate a transmission path response and correct the transmission path response. At this time, since the received packet normally contains both transmission path response and noise, a simple comparison with the known preamble pattern will cause the noise component to appear as error in the estimation of the transmission path response. Thus, the transmission path response cannot be precisely corrected. Therefore, by utilizing the fact that the preamble pattern is repeated a plurality of times, an averaging portion 234 as shown in FIG. 3 averages the received preamble patterns that have just been converted to the frequency-axis information by the FFT 220, so that the noise can be reduced. Thus, a transmission-path-response estimating portion 231 can estimate the response with less noise.

In the demodulation system shown in FIGS. 1 and 3, a long delay time is taken until the transmission path response is corrected from the time when the packet is received. Thus, there is a defect that the period becomes long until the transmission of a reply to the demodulated packet is started after the completion of the receiving at the antenna terminal. The problems that we must solve to remove this defect will be further described below.

FIG. 11B is a timing chart of the OFDM demodulator circuit examined by the inventers before this invention. The first problem will be mentioned. The factor that increases the delay time, Td taken until the transmission path response is corrected can be considered to lie in the fact that, first the frequency error estimating/correcting portion 210 sequentially corrects the repeated preamble patterns (patterns T1 and T2), and secondly the received-data holder 211 once holds the repeated patterns in order for the frequency error estimating/correcting portion 210 to estimate the frequency error, and the averaging portion 234 holds the repeated patterns in order for the repeated patterns to be averaged when the equalizer 230 estimates the transmission path response.

The second problem lies in the following points. While the gain of the RF portion to the packet received is automatically controlled to be within the dynamic range of the A/D converter as described above, setting the gain to the packet in a longer time after the reception will cause the received data to be demodulated with the dynamic range disregarded the more. Therefore, it is important to faster detect the packet reception and appropriately control the gain. The detection of the received signal is generally performed by RSSI (Received Signal Strength Indicator) or by computation of power using the receive signal. The received data, before being processed for synchronizing detection and frequency correction, is passed through the FIR filter as shown in FIG. 20 so that the out-of-band high-frequency components can be removed. The output from this FIR filter is normally used for the power to be computed. At this time, if the number of taps (the number of sets of delay elements and multipliers) of the FIR filter is increased, the received signal passes through a large number of the delay elements. Therefore, the delay time during which the signal enters in and exits from the filter becomes great, and thus it takes a long time to detect the packet. If the tap number is decreased contrary to the above, the delay time is decreased, but the filter performance is deteriorated so that the demodulation cannot be satisfactorily performed.

The third problem lies in the following points. FFT (Fast Fourier Transform) generally makes butterfly computation, and uses the arrangement shown in FIG. 19 in order to suppress the circuit scale. In other words, the time-axis direction data is once stored in an input data memory 221, and when data necessary for computation is all stored, the data is passed through a selector 225 and supplied to a butterfly operation part 222, where the butterfly computation is performed. Then, the computation result is stored in a computation result memory 223 (first stage). Then, the selector 225 is switched to select the data read from the memory 223 and again supplies the read data to the butterfly operation part 222 where it is subjected to the computation, and the computed result is stored in the memory 223 (second stage). The stored data is once more subjected to the computation in the butterfly operation part 222, and the computed result is produced as the frequency-axis direction data (third stage). Thus, since the processes in those stages are serially performed as shown in FIG. 9B, the processing time is long. The butterfly operation part 222 is formed of adders and complex multipliers. In order to decrease the processing time, it is necessary to make those stage processes in parallel. Thus, parallel processing will need a plurality of adders and complex multipliers, making the circuit scale extremely large.

It is an objective of the invention to provide a communication semiconductor integrated circuit having, built in, an OFDM demodulator circuit capable of reducing the delay time taken until the packet data is demodulated from being received by solving the above problems, and a radio communication system using this integrated circuit.

The above objective, other objectives and novel features of this invention will be apparent from the detailed description of this specification and the accompanying drawings.

The summary of the typical examples of the invention disclosed in this application is as follows.

The invention in this application is applied to a transmission system for the OFDM modulated signal of which the transmitted packet has a preamble that includes at least two or more repetitive fixed-signal sequences. On the receiver side, an OFDM demodulator circuit is provided that has a frequency-error estimating/correcting function to estimate and correct for the frequency error by using the received preamble, and a transmission path response estimating/correcting function to estimate and correct the transmission path response by using the received preamble. More specifically, this OFDM demodulator circuit has delay means for delaying the received preamble, the frequency-error estimating/correcting function to estimate the frequency error from the received preamble and the delayed preamble produced from the delay means and correct for the frequency error on the basis of the estimated signal, averaging means for averaging the received preamble corrected by the frequency-error estimating/correcting function before FFT process, and the transmission path response estimating/correcting function to estimate the transmission path response on the basis of the result of the FFT processing of the averaged preamble, and make the demodulation of the OFDM modulated signal from the estimated result of the transmission path response.

According to the above means and functions, the preamble is averaged on the time axis, and after the averaging the preamble is converted to the frequency-axis information. Thus, it possible to decrease the delay time taken until the packet is corrected for the transmission path response from being received. The frequency-error estimating/correcting function may be constructed (see FIG. 4) so that the delayed preamble produced from the delay means and the subsequently received preamble can be simultaneously corrected for the frequency error on the basis of the estimated frequency error, and then averaged. Alternatively, it may be constructed as follows (see FIG. 12). The second delay means for delaying the preamble corrected for the frequency error is separately provided in addition to the first-mentioned delay means. Multiple preambles are sequentially and separately corrected for the frequency error, and then the samples of the previous preamble delayed by the second delay means are averaged at the same time that the samples of the subsequently received preamble are corrected for the frequency error.

In addition, according to the invention of this application, there is provided a demodulator circuit having memory means for holding the received preamble, frequency-error estimating/correcting function to estimate the frequency error from the received preamble and the preamble held in the memory means and correct for the frequency error on the basis of the estimated signal, averaging means for averaging the received preamble corrected by the frequency-error estimating/correcting function before FFT process, and a transmission path response estimating/correcting function to estimate the transmission path response on the basis of the result of FFT processing of the averaged preamble and make the demodulation of the OFDM modulated signal from the result of the estimated transmission path response. Since the memory means for holding the received preamble is provided, the stored preamble can be read out at an arbitrary timing so that the frequency error can be estimated on the basis of a far preamble separated on a time-basis. Therefore, more precise estimation can be performed.

According to the invention of this application, there is also provided a demodulator circuit having gain adjusting means for adjusting the gain to the received signal, A/d converter means for converting the received analog signal adjusted in gain to a digital signal, a finite impulse response type filter (FIR filter) for removing the out-of-band component signal from the received digital signal, and an auto gain control for automatically controlling the FIR filter output by using the gain adjusting means, so that the stage number of the FIR filter can be changed by switching before and after of the gain control. By this construction to change the filter stage number, it is possible to decrease the stage number of the FIR filter at the time of automatic gain control, and hence reduce the delay time. Thus, the time taken for the gain control can be shortened.

Furthermore, according to the invention of this application, a fast Fourier transform (FFT) function can be provided to convert the frequency error corrected signal to the frequency-axis information. The butterfly computation is used for the FFT process, and parts of the butterfly computation are performed in parallel. Since the butterfly computation in the FFT process includes a complex-computation stage and a plurality of simple-computation stages, the complex-computation stage process is performed by a common arithmetic circuit in a time-sharing manner, and the simple-computation stage processes are carried out by separate special arithmetic circuits so that the circuit scale can be suppressed from increasing and that the processing time can be reduced.

The effect will be described in brief that can be achieved by the typical examples of the invention disclosed in this application.

It is possible to reduce the delay time taken until the demodulated signal is obtained after the received packet is converted to the base band signal.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of the construction of the OFDM demodulator circuit examined by the inventors before this invention.

FIG. 2 is a diagram showing the format of the packet regulated by the standard, IEEE802.11a.

FIG. 3 is a block diagram showing the arrangements of elements ranging from the frequency error estimating/correcting portion to the equalizer in the OFDM demodulator circuit examined by the inventors before this invention.

FIG. 4 is a block diagram showing the arrangements of elements ranging from the frequency error estimation/correction portion to the equalizer in the OFDM demodulator circuit according to the invention.

FIG. 5 is a block diagram showing the construction of the frequency error-estimating portion in the OFDM demodulator circuit of an embodiment according to the invention.

FIG. 6 is a timing chart for the frequency error estimation in the OFDM demodulator circuit according to this embodiment.

FIG. 7 is a block diagram showing the construction of the frequency error correcting portion and averaging portion in the OFDM demodulator circuit according to this embodiment.

FIG. 8 is a block diagram showing the construction of the FFT portion in the OFDM demodulator circuit according to this embodiment.

FIG. 9A is a timing chart for the FFT portion of the OFDM demodulator circuit according to this embodiment.

FIG. 9B is a timing chart for the FFT portion of the OFDM demodulator circuit examined by the inventors before this invention.

FIG. 10 is a block diagram showing the construction of the transmission path response estimating/correcting portion in the OFDM demodulator circuit according to this embodiment.

FIG. 11A is a timing chart for the OFDM demodulator circuit according to this embodiment.

FIG. 11B is a timing chart for the OFDM demodulator circuit examined by the inventors before this invention.

FIG. 12 is a block diagram of a second embodiment of the OFDM demodulator circuit.

FIG. 13 is a block diagram showing the arrangements of the frequency error correcting portion, averaging portion and delaying portion in the OFDM demodulator circuit of the second embodiment.

FIG. 14 is a timing chart for the OFDM demodulator circuit of the second embodiment.

FIG. 15 is a block diagram showing the construction of the FIR filter in the OFDM demodulator circuit of a third embodiment.

FIG. 16 is a block diagram showing the construction of the OFDM demodulator circuit of the third embodiment.

FIG. 17A is a timing chart for the OFDM demodulator circuit of the third embodiment.

FIG. 17B is a timing chart for the OFDM demodulator circuit examined by the inventors before this invention.

FIG. 18 is a block diagram showing an example of the construction of the whole wireless LAN system that meets the IEEE802.11a standard and that uses the OFDM demodulator circuit according to this invention.

FIG. 19 is a block diagram showing the construction of the FFT portion in the OFDM demodulator circuit examined by the inventors before this invention.

FIG. 20 is a block diagram showing the construction of the FIR filter portion in the OFDM demodulator circuit examined by the inventors before this invention.

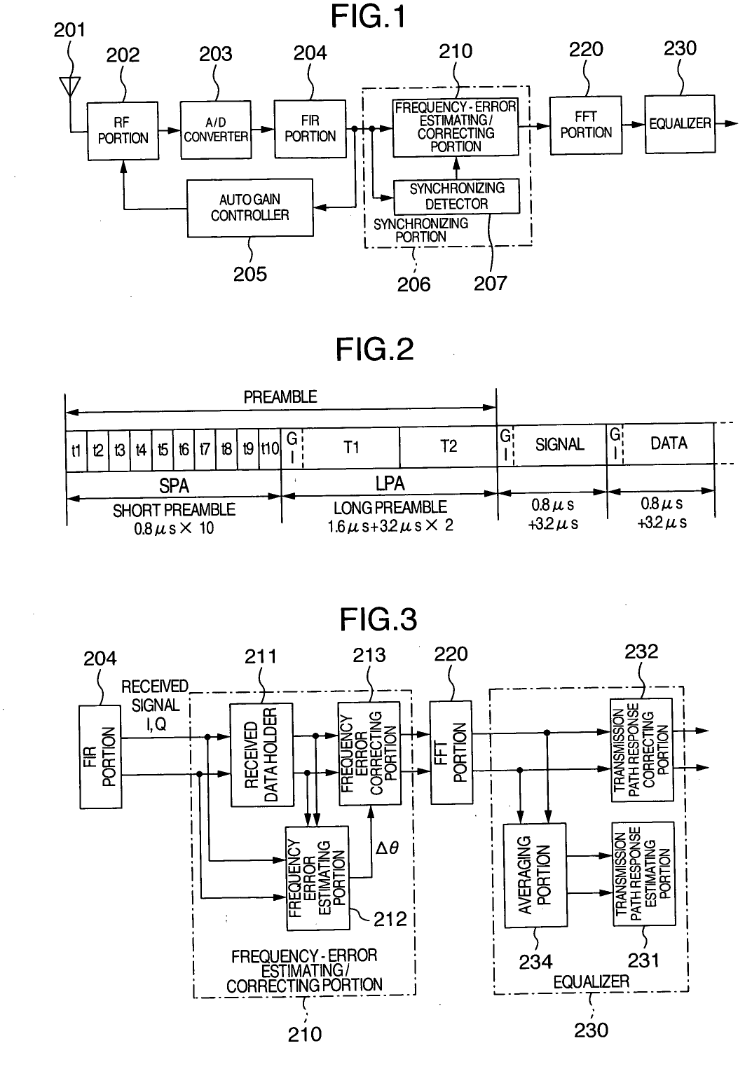

### DESCRIPTION OF THE EMBODIMENTS

Embodiments of an OFDM demodulator circuit according to the invention will be described. In the embodiments of the invention, this OFDM modulator constitutes, for example, a wireless LAN system that meets the IEEE802.11a standard.

### Embodiment 1

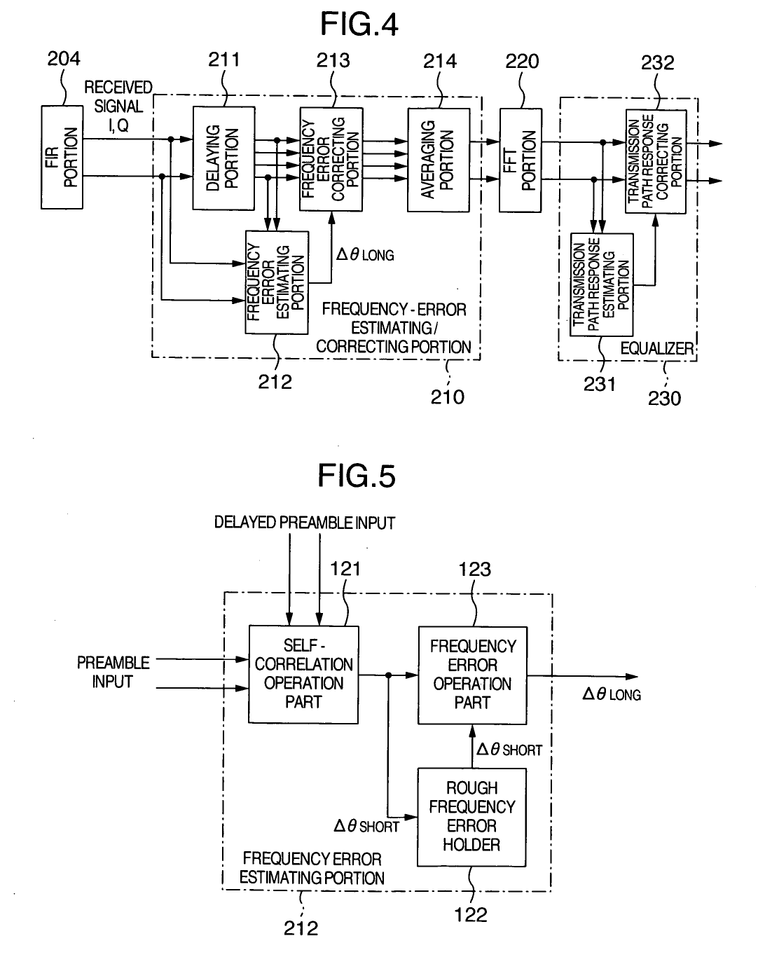

FIG. 4 shows the first embodiment of the OFDM demodulator circuit. The OFDM demodulator circuit of this embodiment has, as does the OFDM demodulator circuit examined by the inventors before this invention, the FIR filter 204 that removes the out-of-band high-frequency components from the received and A/D-converted signals I and Q, the frequency error estimating/correcting portion 210 that estimates and corrects for the frequency error, the FFT portion 220 that converts the received signal from the time-axis information to the frequency-axis information, and the equalizer 230 that estimates and corrects the transmission path response by comparing the preamble pattern of the received packet converted to the frequency-axis information and a known preamble pattern.

The frequency error estimating/correcting unit 210 has the delaying portion 211 that is formed of delay elements and that delays the short preamble of the received packet by a period of 16 samples, the frequency error estimating portion 212 that estimates the frequency error from the delayed short preamble pattern and the following received short preamble pattern, the frequency error correcting portion 213 that corrects for the frequency error by use of the detected frequency estimate, the delayed short preamble pattern and the following received short preamble pattern, and an averaging portion 214 that averages the corrected and received signal with respect to time.

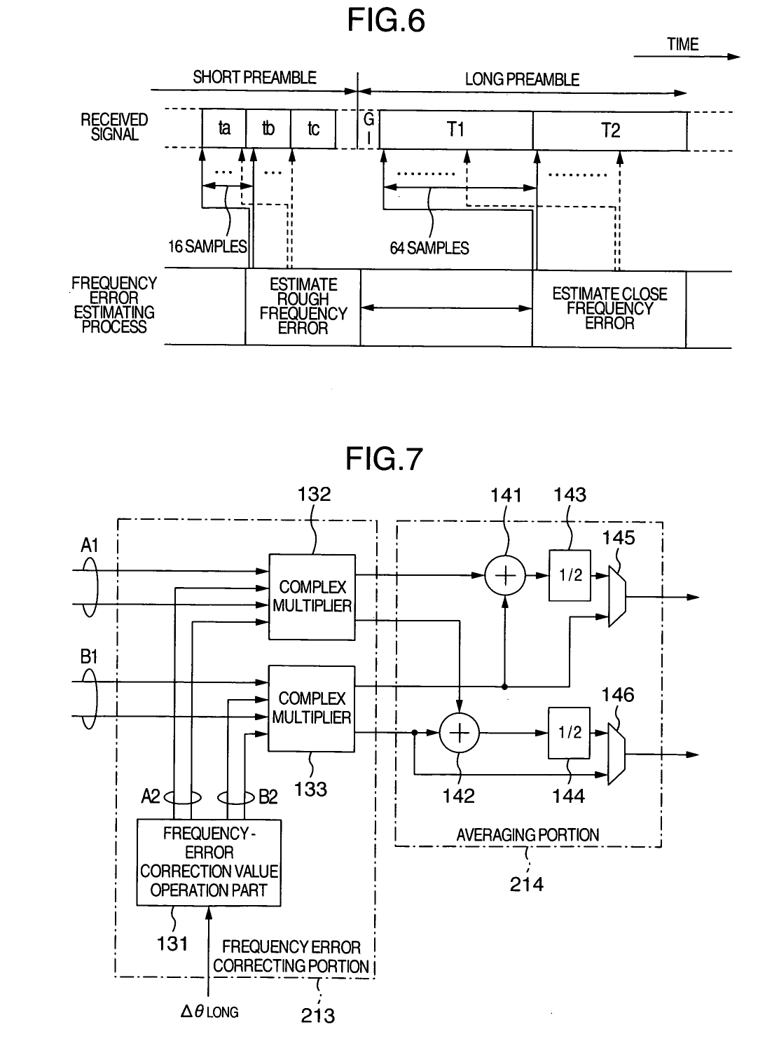

FIG. 5 is a block diagram of the frequency-error estimating portion 212. FIG. 6 is a timing chart for the operation of the frequency-error estimating portion 212. The frequency-error estimating portion 212 has a self-correlation operation part 121, a rough frequency error holder 122, and a frequency error operation part 123.

The frequency-error estimating portion 212 in this embodiment can estimate the frequency error by using the correlation between the repetitive pattern signals of the short and long preambles of the received packet, or by the complex multiplication of the complex conjugate signal of the signal delayed by the repetition signal interval (16-sample period) and the following repetitive signal to detect the amount of phase rotation. Specifically, the self-correlation operation part 121 obtains the correlation between the repetitive pattern ta of short preamble delayed a period of 16 samples, and the repetitive pattern tb of the following received short preamble.

Here, if the received signals I, Q of the short preamble delayed a period of 16 samples are represented by short00_i, short00_q, and the received signals I, Q of the following short preamble by short16_i, short16_q, respectively, the I-component correlation and Q-component correlation are respectively given by
(short00_i×short16_i)+(short00_q×short16_q) and
(short00_i×short16_q)−(short00_q×shor16_i).

If the valves obtained by summing the above correlation values for 16 samples for the reduction of the noise effect are represented by quad16_i, and quad16_q, respectively, the rough frequency-error estimate Δθ_{SHORT} is given by
Δθ_{SHORT}=arctan(quad16_{—}q/quad16_{—}i)

The rough frequency-error estimate Δθ_{SHORT} thus obtained is stored in the rough frequency-error holder 122. Then, the delaying portion 211 delays the next received long preamble T1 by 64 samples to produce the delayed preamble. This delayed preamble and the next received long preamble T2 are supplied to the self-correlation operation part 121 where the correlation is obtained from each of 64 samples. The frequency-error operation part 123 receives this correlation and the previously estimated rough frequency error and performs more precise frequency-error estimation.

If the received signals I, Q of the long preamble delayed 64 samples are represented by long00_i, long00_q, and the received signals I, Q of the following long preamble by long64_i, long64_q, respectively, the I-component correlation and Q-component correlation are respectively given by
(long00_×long64_i)+(long00_q×long64_q), and
(long00_i×long64_q)−(long00_q×long64_i)

If the 32-sample sums of the above correlation values for the reduction of the noise effect are represented by quad64_i, quad64_q, respectively, the close frequency estimate Δθ_{LONG} is given by
Δθ_{LONG}=arctan(quad64_{—}q/quad64_{—}i)+α(Δθ_{SHORT},quad64_{—}i, quad64_{—}q)

Here, α(Δθ_{SHORT}, quad64_i, quad64_q) is a phase correction value determined by Δθ_{SHORT}, quad64_i, quad64_q. The frequency-error estimate Δθ_{LONG} thus obtained is supplied to the frequency-error correcting portion 213.

FIG. 7 shows an example of the construction of the frequency-error correcting portion 213 and averaging portion 214.

The frequency-error correcting portion 213 has a frequency-error correction operation part 131 and two complex multipliers 132, 133. The long preamble delayed 64 samples by the delaying portion 211 is supplied through an input path A1 to one complex multiplier 132, and the next received long preamble is supplied through an input path B1 to the other complex multiplier 133 so that they can be simultaneously corrected for the frequency error. The frequency-error correction operation part 131 produces a frequency-error correction value A2 of cos (Δθ_{LONG}×k), sin (Δθ_{LONG}×k) for the first long preamble sample, and a frequency-error correction value B2 of cos (Δθ_{LONG}×(64+k)), sin (Δθ_{LONG}×(64+k)) for the second long preamble sample, where k (k=0, 1, . . . , 63) represents the sample position from the symbol timing.

The complex multipliers 132, 133 make frequency-error correction by
long0f_{—}i[k]=long0_{—}i[k]×cos(Δθ_{LONG}×k)−long0_{—}q[k]×sin(Δθ_{LONG}×k)
long0f_{—}q[k]=long0_{—}i[k]×sin(Δθ_{LONG}×k)−long0_{—}q[k]×cos(Δθ_{LONG}×k)
where long0_i[k] and long0_q[k] represent the I-component and Q-component at the sample position k of the long preamble delayed 64 samples before correction, and long0f_i[k] and long0f_q[k] the I-component and Q-component at the sample position k of the long preamble delayed 64 samples after correction.

In addition, if the I-component and Q-component of the next received long preamble at the sample position k before correction are represented by long1_i[k] and long1_q[k], and the I-component and Q-component of the next received long preamble at the sample position k after correction by long1f_i[k] and long1f_q[k], respectively, the frequency error is corrected for by the following expressions.
long1f_{—}i[k]=long1_{—}i[k]×cos(Δθ_{LONG}×(64+k))−long1_{—}q[k]×sin(Δθ_{LONG}×(64+k))
long1f_{—}q[k]=long1_{—}i[k]×sin(Δθ_{LONG}×(64+k))−long1_{—}q[k]×cos(Δθ_{LONG}×(64+k))

The long preambles corrected for frequency error by the frequency-error correcting portion 213 are supplied to the averaging portion 214. The averaging portion 214 has two adders 141, 142, two 1/2-circuits 143, 144 and two selectors 145, 146. For each of the 64 samples of the frequency-error corrected long preambles, the adders 141, 142 execute addition at each sampling timing, and the 1/2-circuits 143, 144 divide the addition results by 2 to average, thus producing the averaged outputs.

Since the signal symbol SIGNAL and data symbol DATA that follow the long preambles are not necessary to average, the received data fed through the input path B1 and the frequency-error correction value B2, after the averaged long preambles are produced, are supplied to and corrected for the frequency error by the complex multipliers 132, 133, and they are directly produced without averaging by switching the input ends of the selectors 145, 146. At this time, 64 samples per symbol are produced, but the guard intervals are eliminated.

The average long preambles thus obtained are supplied to the FFT portion 220, where multicarrier demodulation is performed so that the time-axis direction OFDM modulated signal is converted to the frequency-axis direction subcarrier signals. The long preambles converted to the subcarriers are supplied to the equalizer 230. The transmission path response-estimating portion 231 estimates and corrects the transmission path response.

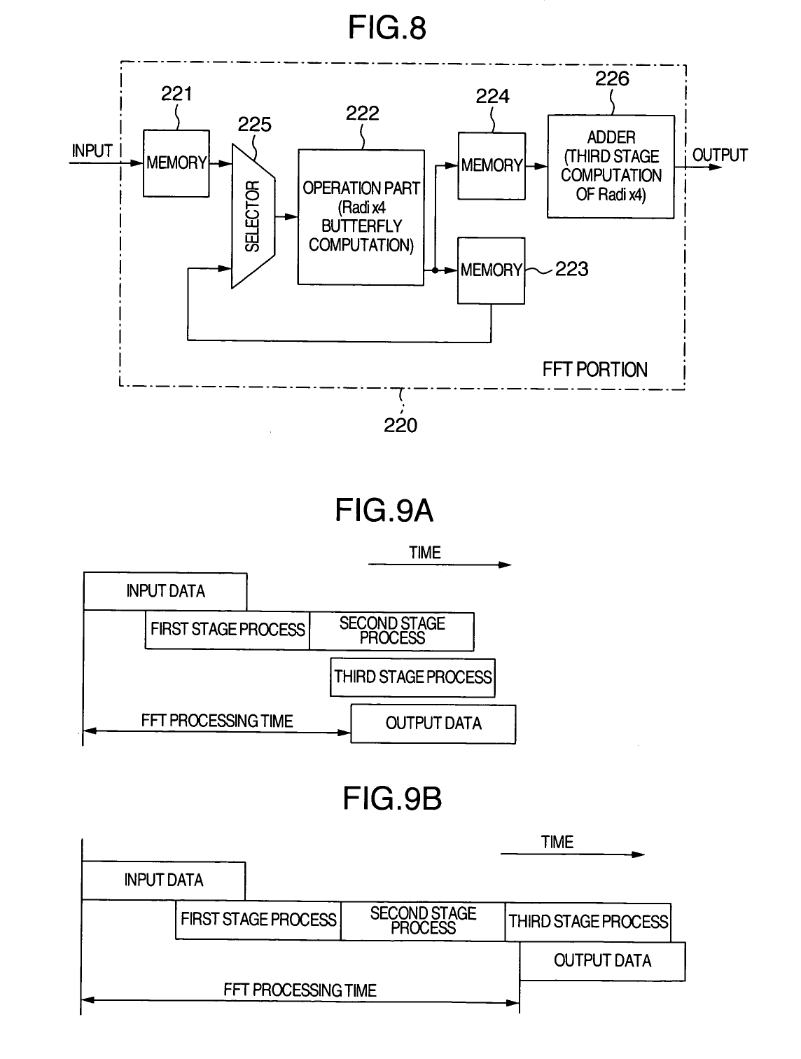

FIG. 8 shows an example of the construction of the FFT portion 220 in this embodiment.

The FFT portion 220 in this embodiment has the memory 221 for temporarily holding the input from the frequency-error estimating/correcting portion 210, the operation part 222 for making butterfly computation, memories 223, 224 for holding the computation results, the selector 225 that selectively supplies either the input from the frequency-error estimating/correcting portion 210 or the computation result stored in the memory 223 to the butterfly operation part 222, and an adder 226 for making code conversion and addition. While butterfly computation of Radix2 and butterfly computation of Radix4 are known as the butterfly computation in the FFT portion 220, the butterfly operation part 222 in this embodiment is constructed to make butterfly computation of Radix4. The butterfly computation of Radix4 is composed of three stage computations.

The algorithm for the butterfly computation of Radix4, x[n]→X[k] (n=0, 1, . . . , 63; k=0, 1, . . . , 63), by the 64-point FFT will be described below.

[First Stage]

The first stage computation of Radix4 is shown by the following equation (1). In the FFT portion 220 of this embodiment, this computation is performed by the butterfly operation part 222, and the computation result is stored in the memory 223.

$$\begin{matrix}n = 16 {n}_{1} + {n}_{2}^{′} ( {n}_{1} = 0 , 1 , 2 , 3 ; {n}_{2}^{′} = 0 , 1 , … , 15 ) \\ k = {k}_{1} + 4 {k}_{2}^{′} ( {k}_{1} = 0 , 1 , 2 , 3 ; {k}_{2}^{′} = 0 , 1 , 2 , … , 15 ) \\ X [ k ] = {\sum }_{n = 0}^{63} x [ n ] {W}_{64}^{n k} \\ = {\sum }_{{n}_{2}^{′} = 0}^{15} {{\sum }_{{n}_{1} = 0}}^{3} x [ 16 {n}_{1} + {n}_{2}^{′} ] {W}_{64}^{( 16 {n}_{1} + {n}_{2}^{′} ) ( {k}_{1} + 4 {k}_{2}^{′} )} \\ = {\sum }_{{n}_{2}^{′} = 0}^{15} {{\sum }_{{n}_{1} = 0}}^{3} x [ 16 {n}_{1} + {n}_{2}^{′} ] {W}_{64}^{16 {n}_{1} {k}_{1}} {W}_{64}^{64 {n}_{1} {k}_{2}^{′}} {W}_{64}^{{n}_{2}^{′} {k}_{1}} {W}_{64}^{4 {n}_{2}^{′} {k}_{2}^{′}} \\ = {\sum }_{{n}_{2}^{′} = 0}^{15} ( {{\sum }_{{n}_{1} = 0}}^{3} x [ 16 {n}_{1} + {n}_{2}^{′} ] {W}_{4}^{{n}_{1} {k}_{1}} {W}_{64}^{{n}_{2}^{′} {k}_{1}} ) {W}_{16}^{{n}_{2}^{′} {k}_{2}^{′}} \\ = {\sum }_{{n}_{2}^{′} = 0}^{15} {\tilde{x}}_{1} [ {k}_{1} , {n}_{2}^{′} ] {W}_{16}^{{n}_{2}^{′} {k}_{2}^{′}} \\ {W}_{N}^{n k} = exp ( - \frac{2 π n k}{N} ) = cos ( \frac{2 π n k}{N} ) - j \cdot sin ( \frac{2 π n k}{N} )\end{matrix} \qquad [ Equation ( 1 ) ]$$

[Second Stage]

The computation of the second stage of Radix4 is given by the following equation (2). In the FFT portion 220 of this embodiment, the value stored in the memory 223 is read out and supplied through the selector 225 to the butterfly operation part 222. The computation result from the operation part 222 is stored in the memory 224.

$$\begin{matrix}{n}_{2}^{′} = 4 {n}_{2} + {n}_{3} ( {n}_{2} = 0 , 1 , 2 , 3 ; {n}_{3} = 0 , 1 , 2 , 3 ) \\ {k}_{2}^{′} = {k}_{2} + 4 {k}_{3} ( {k}_{2} = 0 , 1 , 2 , 3 ; {k}_{3} = 0 , 1 , 2 , 3 ) \\ {\sum }_{{n}_{2}^{′} = 0}^{15} {\tilde{x}}_{1} [ {k}_{1} , {n}_{2}^{′} ] {W}_{16}^{{n}_{2}^{′} {k}_{2}^{′}} = {\sum }_{{n}_{3} = 0}^{3} {{\sum }_{{n}_{2} = 0}}^{3} {\tilde{x}}_{1} [ {k}_{1} , 4 {n}_{2} + {n}_{3} ] \\ {W}_{16}^{( 4 {n}_{2} + {n}_{3} ) ( {k}_{2} + 4 {k}_{3} )} \\ = {\sum }_{{n}_{3} = 0}^{3} {{\sum }_{{n}_{2} = 0}}^{3} {\tilde{x}}_{1} [ {k}_{1} , 4 {n}_{2} + {n}_{3} ] \\ {W}_{16}^{4 {n}_{2} {k}_{2}} {W}_{16}^{16 {n}_{2} {k}_{3}} {W}_{16}^{{n}_{3} {k}_{2}} {W}_{16}^{4 {n}_{3} {k}_{3}} \\ = {\sum }_{{n}_{3} = 0}^{3} ( {{\sum }_{{n}_{2} = 0}}^{3} {\tilde{x}}_{1} [ {k}_{1} , 4 {n}_{2} + {n}_{3} ] \\ {W}_{4}^{{n}_{2} {k}_{2}} {W}_{16}^{{n}_{3} {k}_{2}} ) {W}_{4}^{{n}_{3} {k}_{3}} \\ = {\sum }_{{n}_{3} = 0}^{3} {\tilde{x}}_{2} [ {k}_{1} , {k}_{2} {n}_{3} ] {W}_{4}^{{n}_{3} {k}_{3}}\end{matrix} \qquad [ Equation ( 2 ) ]$$

[Third Stage]

The computation for the third stage of Radix4 is given by the following equation (3). In the FFT portion 220 of this embodiment, this computation is performed by the operation part 226, and the result is produced.

$${\sum }_{{n}_{3} = 0}^{3} {\tilde{x}}_{2} [ {k}_{1} , {k}_{2} , {n}_{2} , {n}_{3} ] {W}_{4}^{{n}_{3} {k}_{3}} \qquad [ Equation ( 3 ) ]$$

If we focus attention on the third stage of the above algorithm, the term W₄^{nk} of the equation (3) can be expressed by the equation (4). From the equation (4), it will be seen that this term only takes one of values −1, 0 and 1 as the result from computing the cosine and sin of the equation (4).

$${W}_{4}^{n k} = exp ( - \frac{2 π n k}{4} ) = cos ( \frac{2 π n k}{4} ) - jsin ( \frac{2 π n k}{4} ) \qquad [ Equation ( 4 ) ]$$

Therefore, since the multiplication processing for the third stage can be performed as any one of sign change, 0 and no conversion, it is substantially not necessary, but can be made only by sign change and addition, so that the third stage is easier to make compute than the first and second stages. Thus, in the FFT portion 220 of this embodiment, an adder of a smaller circuit scale than the multiplier is used to construct the operation part 226, and the third stage computation is carried out in parallel with the second stage computation.

In the FFT portion 220 of this embodiment, the memory 221 stores the received signal corrected for frequency error by the frequency-error estimating/correcting portion 210 so as to temporarily hold the stored signal until necessary data is inputted to the first stage computation. When the necessary data is obtained, the operation part 222 makes the first stage computation (equation (1)), and the result is stored in the memory 223 to temporarily hold until the first stage computation is completed. Then, the selector 225 is switched to select the result of the first stage computation, and the operation part 222 makes the second stage computation (equation (2)) using the selected result. The result of this computation is stored in the memory 224. At this time, the memory 224 holds only the minimum portion necessary for the third stage computation, and the adder 226 makes the third stage computation (equation (3)) without waiting for the completion of the second stage computation.

Thus, as illustrated in the timing chart of FIG. 9A, the second stage computation and third stage computation can be performed in parallel. FIG. 19 shows an example of the construction of the FFT portion examined by the inventors before this invention. This FFT portion examined by the inventors before this invention is constructed not to have memory 224 and adder 226, but to have one operation part 222 by which all the computations for the first stage through third stage are sequentially performed in a time shoring manner. Therefore, the FFT processing time from the start of the data input to the data output in this embodiment shown in FIG. 9A is about 1 stage reduced than that shown in FIG. 9B that shows the timing chart for the FFT portion examined by the inventors before this invention.

While all stages can be processed in parallel by separately providing the first stage operation part and second stage operation part, parallel processing for only the third stage as in this embodiment can make it unnecessary to provide an operation part for computing the second stage, and thus the circuit scale can be reduced as compared with the parallel processing for all stages. Since the third stage computation can be performed by simple sign change and addition as described above, even the addition of the circuit (adder 226) for the third stage computation as in this embodiment results in slight increase of circuit scale.

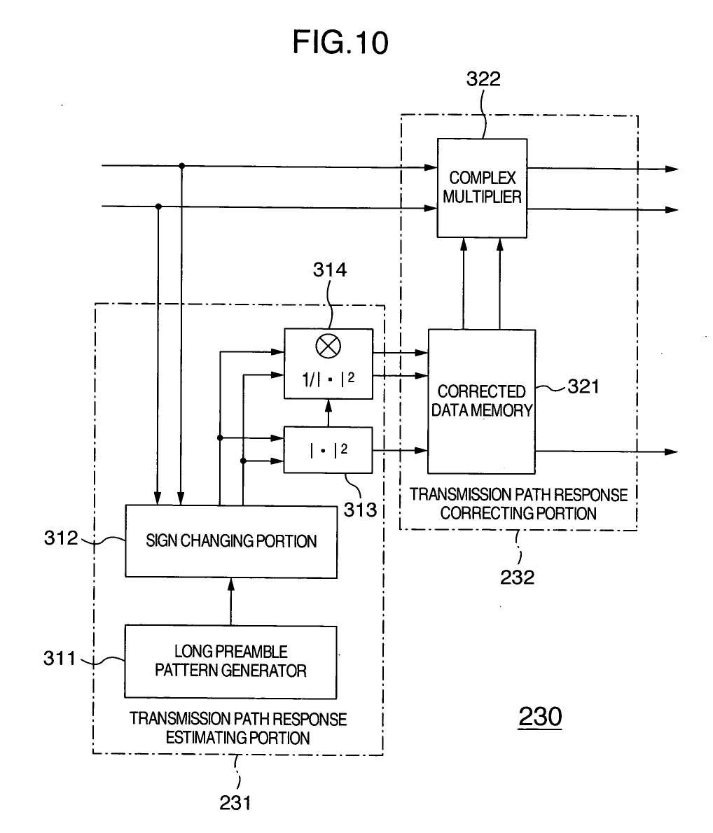

FIG. 10 is a block diagram of the transmission path response-estimating portion 231 and transmission path response-correcting portion 232. In the transmission path response estimating portion 231, a long preamble pattern generator 311 generates known long preamble sign information, and supplies it to a positive/negative sign changing portion 312, where the sign of the received long preamble is properly changed according to the known sign information so that the transmission path response can be estimated. Then, a power operation part 313 determines the magnitude of the estimate (the square of the estimate: |·|²) for each subcarrier, and a complex multiplying/dividing portion 314 finds the reciprocal of the estimate. Thus, the transmission path response correction value can be calculated, and stored in a correction-data holding memory 321. Then, a complex multiplier 322 makes complex multiplying of the signal symbol SIGNAL and data symbol DATA that are converted to subcarrier signals by the FFT portion 220 and that follow the long preamble by using the transmission path response correction value stored in the memory 321, so that they can be corrected for the transmission path response.

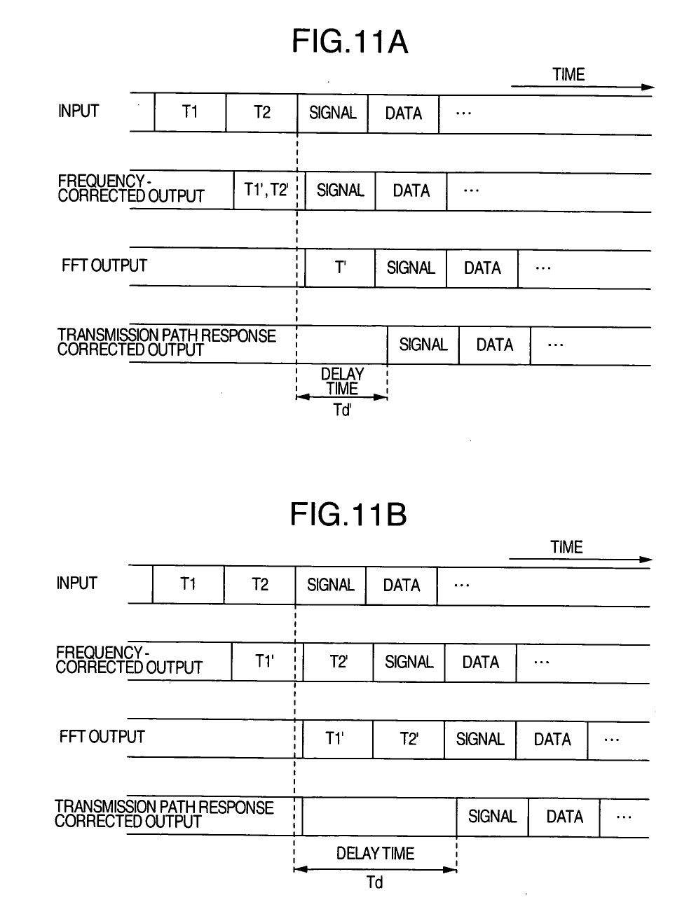

The above processing will be mentioned with reference to the timing chart of FIG. 11A. In FIG. 11A, the timing for the short preamble is not shown.

The frequency error is estimated from the long preamble patterns T1, T2, and preamble patterns T1′, T2′ corrected for the frequency error are produced at a time when the frequency error correction value is produced. Subsequently, averaging is performed, and the noise-reduced long preamble T′ is produced as subcarrier signals at the FFT output. Therefore, the transmission path response can be started to estimate at the same time that the preamble T′ is produced, and the following signal symbol SIGNAL can be started to correct for the transmission path response. Thus, if the timing chart for this embodiment is compared with that of FIG. 11B for the demodulator circuit of FIG. 3 examined by the inventors before this invention, it will be understood that the delay time Td in which the signal symbol SIGNAL of the received packet is inputted and corrected for the transmission path response can be reduced by one symbol to change to a delay time Td′ as shown in FIG. 11A.

Here, let us show that the averaging before the FFT process is equivalent to that after the FFT process.

If the signals (N sample number) obtained by sampled at two different times during the same interval are represented by x(n)=(x₀, x₁, x₂, . . . , x_{N-1}), y(n)=(y₀, y₁, y₂, . . . , y_{N-1}), discrete Fourier transform of those signals will yield the following equation (5).

$$\begin{matrix}X ( {k}_{x} ) = {\sum }_{n = 0}^{N - 1} ( {x}_{re} ( n ) + j {x}_{im} ( n ) ) ( cos \frac{2 π n {k}_{x}}{N} - j sin \frac{2 π n {k}_{x}}{N} ) \\ Y ( {k}_{y} ) = {\sum }_{n = 0}^{N - 1} ( {y}_{re} ( n ) + j {y}_{im} ( n ) ) ( cos \frac{2 π n {k}_{y}}{N} - j sin \frac{2 π n {k}_{y}}{N} )\end{matrix} \qquad [ Equation ( 5 ) ]$$

The IEEE802.11a standard defines the sampling frequency error within ±20 ppm. If two periods in which averaging is performed are considered to be continuous in time within the same symbol (long preamble), the sampling frequency error is negligibly small. Therefore, k=kₓ=k_{y} can be assumed. In addition, it is assumed that the change of transmission path response time in the preamble can be neglected. If the signals of each subcarrier are averaged on the frequency-axis, the following equation (6) can be obtained.

$$\frac{X ( k ) + Y ( k )}{2} = {\sum }_{n = 0}^{N - 1} ( \frac{{x}_{re} ( n ) + {y}_{re} ( n )}{2} + j \frac{{x}_{im} ( n ) + {y}_{im} ( n )}{2} ) ( cos \frac{2 π n k}{N} - j sin \frac{2 π n k}{N} ) \qquad [ Equation ( 6 ) ]$$

From this equation, it will be understood that this equation is equivalent to the expression of the discrete Fourier transform after averaging on the time axis at each sampling timing, and that there is no difference between the case in which averaging is made before FFT process and the case in which averaging is made after FFT process under the above condition. Therefore, the long symbol averaging process can be performed before FFT process as in this embodiment.

(Modification)

The delaying portion 211 formed of delay elements in the embodiment 1 (see FIG. 4) can be replaced by a memory such as RAM (Random Access Memory). In this modification in which a RAM replaces the delaying portion, the short preamble ta is temporarily stored, and the stored short preamble ta and the next fed short preamble tb are supplied to the frequency-error estimating portion 212. The frequency-error estimating portion 212 has the same construction as in the embodiment 1. The self-correlation operation part 121 of the frequency-error estimating portion 212 takes the correlation between the short preambles ta and tb at each of the 16 samples of the repetitive patterns, coarsely estimates the frequency error, and causes the coarse frequency error holder 122 to store this coarse frequency error.

The succeeding long preamble T1 is temporarily stored in the memory, and the stored long preamble T1 and the next succeeding long preamble T2 are supplied to the self-correlation operation part 121. The self-correlation operation part 121 takes the correlation between T1 and T2 at each of the 64 samples and supplies it to the frequency-error operation part 123. The frequency-error operation part 123 estimates more precise frequency error from this correlation and the previously estimated coarse frequency error, and produces the estimate. The subsequent processes are the same as in the embodiment 1, and thus will not be described.

In this modification, since the memory for storing the received signal is used in place of the delaying portion for delaying the inputted received signal, the received signal once stored can be read out at an arbitrary timing. Therefore, if the short preambles of an appropriate level are caused to last for a long time by the fast gain setting in the RF portion 202 at the front stage, the self-correlation can be taken with the 32 sample interval of the short preamble ta and the short preamble tc that is placed after ta by two short preambles, or with the 48 sample interval of ta and td in place of taking the self-correlation of the continuous short preambles ta and tb shown in FIG. 6 when the coarse frequency error is estimated. Thus, it is possible to make more precise error estimation.

In the arrangement where the input stage of the frequency-error estimating/correcting portion 210 is constructed by the delaying portion 211 formed of delay elements as in the embodiment (see FIG. 4), delay elements for two short preambles of ta and tb are necessary to derive the self-correlation of 32-sample interval, and thus the circuit scale increases as compared with the case of deriving the self-correlation from 16-sample interval. However, in this modification, by controlling the write/read timing to the memory, the self-correlation can be taken from a different sample interval without increasing the circuit scale as compared with the case where the self-correlation is derived from the 16-sample interval.

### Embodiment 2

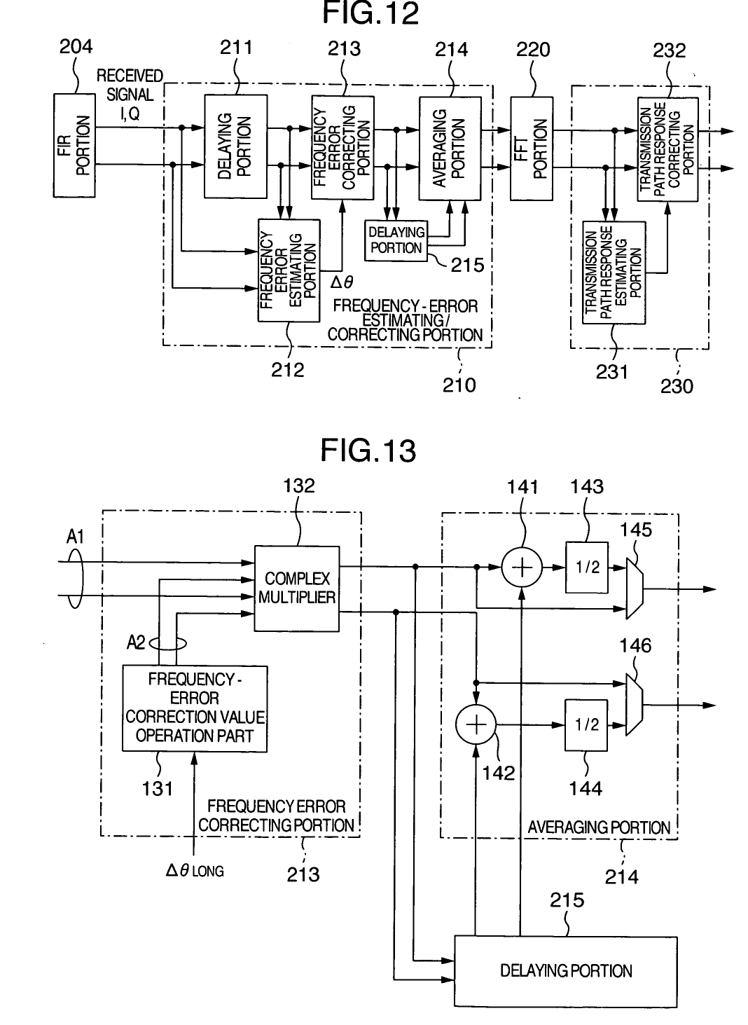

FIG. 12 shows the second embodiment of the OFDM demodulator circuit according to the invention. In this embodiment, the frequency-error estimating/correcting portion 210 has another delaying portion 215 in addition to the delaying portion 211 for holding the short preamble or long preamble for frequency error estimation. This delaying portion 215 is used to delay the long preamble after correction in order that the long preamble can be averaged. The operations up to the output of frequency-error estimate are the same as in the embodiment 1, and thus will not be described. The frequency-error correcting portion 213 is constructed as shown in FIG. 13. From the comparison with the construction of frequency-error correcting portion 213 of the embodiment 1 shown in FIG. 7, it will be apparent that a single complex multiplier is used in this embodiment.

In addition, while the frequency-error correction value operation part 131 in the embodiment 1 is required to find the frequency-error correction value in the light of the frequency error 64 samples ahead, this embodiment is not required to do so. That is, in this embodiment, the frequency-error correction value operation part 131 is required only to sequentially produce the frequency-error correction value A2 in accordance with each sample with the first long preamble start point used as the reference. The first long preamble T1′ corrected for frequency error by using the above correction value A2 in the complex multiplier 132 is temporarily stored in the delaying portion 215. Then, the second long preamble T2 is corrected for frequency error at each sample, and at the same time the samples corresponding to the first corrected long preamble T1′ held in the delaying portion 215 are produced. The averaging portion 214 averages this preamble and the corrected preamble T2′.

The above processing will be described with reference to the timing chart of FIG. 14. In the timing chart of FIG. 14, the short preamble is not shown.

The frequency error is estimated on the basis of the inputted long preamble T1, T2, and the long preamble T1′, T2′ corrected for frequency error are sequentially produced at the correction output. Then, while the preamble T2′ is being produced, the averaging process is performed with the result that the long preamble T′ with noise reduced is produced from the FFT as subcarrier signals. In this embodiment, the transmission path response can be started to estimate at the same time that the output T′ starts to produce from FFT, and the successively fed signal symbol SIGNAL can be corrected for the transmission pass response from its beginning.

### Embodiment 3

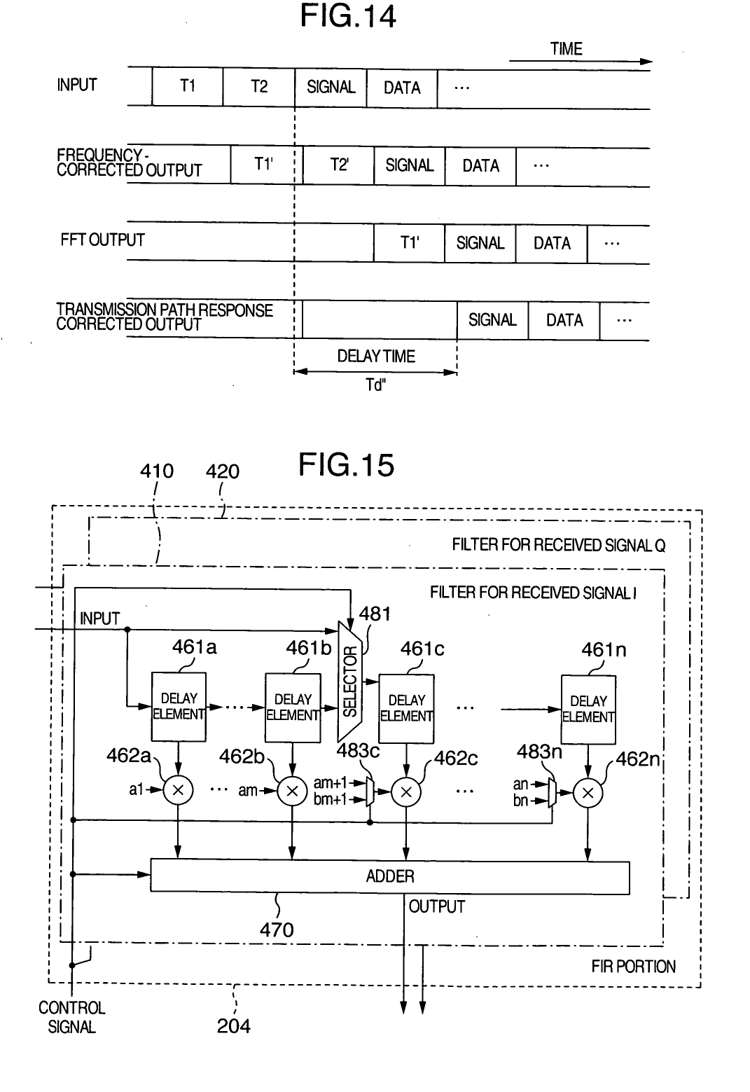

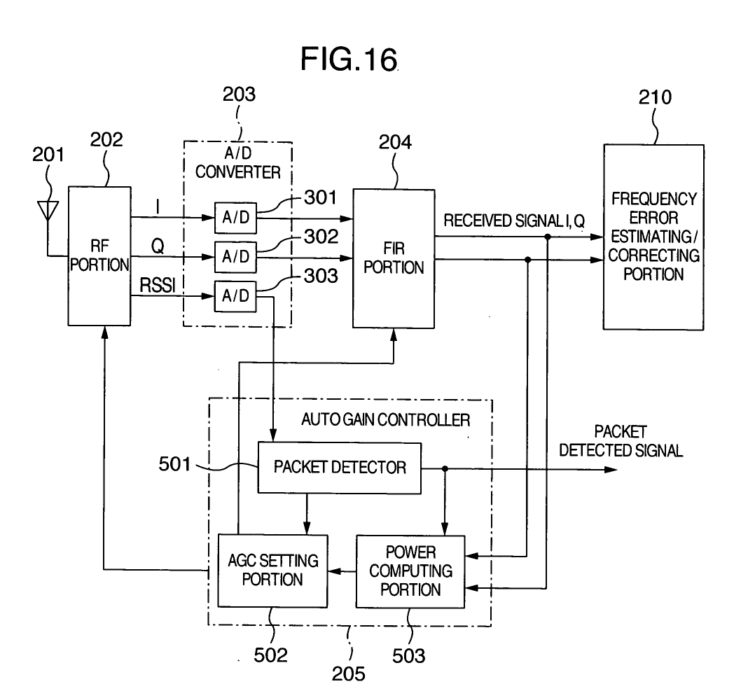

FIG. 15 shows an example of the construction of the FIR portion used in the third embodiment of the OFDM demodulator circuit according to the invention. FIG. 16 shows an example of the construction of a system that has the OFDM demodulator circuit including this FIR portion provided as the demodulator of the wireless LAN.

The FIR portion 204 in this embodiment, as illustrated in FIG. 15, has a filter 410 for received signal I, and a filter 420 for received signal Q. Each filter has a delay stage formed of a plurality of (n) delay elements 461a˜461n connected in series, a multiplier portion formed of multipliers 462a˜462n provided in association with the respective delay elements in order to multiply the delayed signals by predetermined coefficients a1˜an, and an adder 470 for adding the outputs from the multipliers 462a˜462n. In addition, the FIR portion 204 of this embodiment has a selector 481 provided between the m-th delay element 461b and the (m+1)-th delay element 461c so that the input signal can be directly fed to the (m+1)-th delay element 461c without passing through the delay elements 461a ˜461b, and selectors 483c˜483n provided to selectively supply coefficients bₘ₊₁˜bₙ in place of coefficients aₘ₊₁˜aₙ to the multipliers 462c˜462n corresponding to the (m+1)-th and following delay elements 461c˜461n. The FIR filter examined by the inventors before this invention has no selectors 481, 483c˜483n, but has a fixed number of taps (stage number) operated by a single coefficient a₁˜aₙ.

In the system of this embodiment shown in FIG. 16, the signal received by the antenna 201 is amplified and converted down to the base band signal by the RF portion 202. The RF portion 202 produces signals I and Q, and an RSSI signal that indicates the magnitudes of the received signals. The produced I, Q signals and RSSI signal are respectively converted to digital signals by A/D converters 301, 302, 303 provided within the A/D conversion unit 203. A packet detector 501 always monitors the digital RSSI signal about if it meets a predetermined judgment standard, and determines that a packet has been received when it meets. When the packet detector 501 detects that the packet has been received, an AGC setting part 502 determines a rough gain to the AGC circuit provided within the RF portion 202 from the value of the RSSI signal at the detection time, and supplies a gain-setting control signal to the RF portion 202.

In this system of this embodiment, the FIR portion 204, when starting to receive, controls the selector 481 of each of the filters 410, 420 for I and Q to reduce the apparent number of delay stages so that the delay time required for the signal to be processed from the input to the output can be reduced. Therefore, although the received signals I and Q amplified by the RF portion 202 are converted to digital signals by the A/D conversion unit 203, and then fed to the FIR portion 204 so that the out-of-band high-frequency components can be eliminated, the delay time is shortened since the FIR portion 204 is set for the condition in which the number of delay stages is small.

Next, when the received packet is detected, a power computing portion 503 provided within the auto gain control 205 computes the received power on the basis of the received signal produced from the FIR filter, and determines and sets a more precise gain to the AGC circuit provided within the RF portion 203 on the basis of this received power. At this time, an AGC gain setting end signal is transmitted to the FIR portion 204 so that the selector 481, adder 470 and coefficient-selecting selectors 483a˜483n can be controlled to change the stage number and coefficients with which the performance necessary for the normal operation can be achieved. In this way, it is possible to reduce the necessary time taken in the processes from the packet reception to the AGC gain setting.

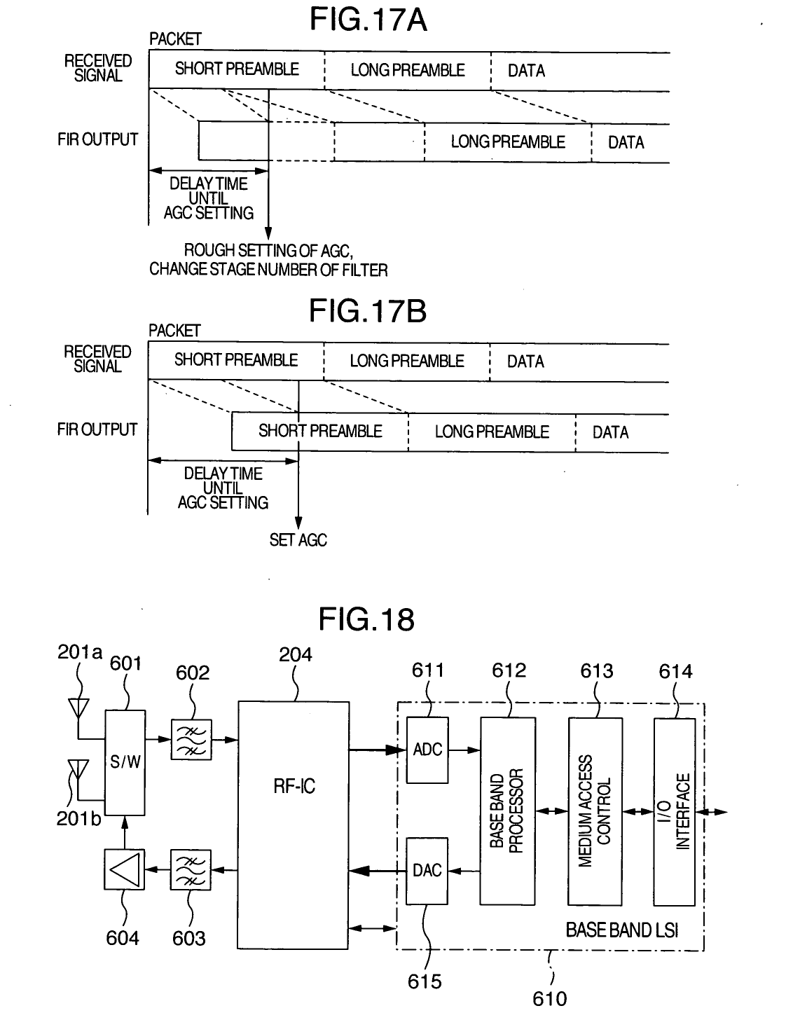

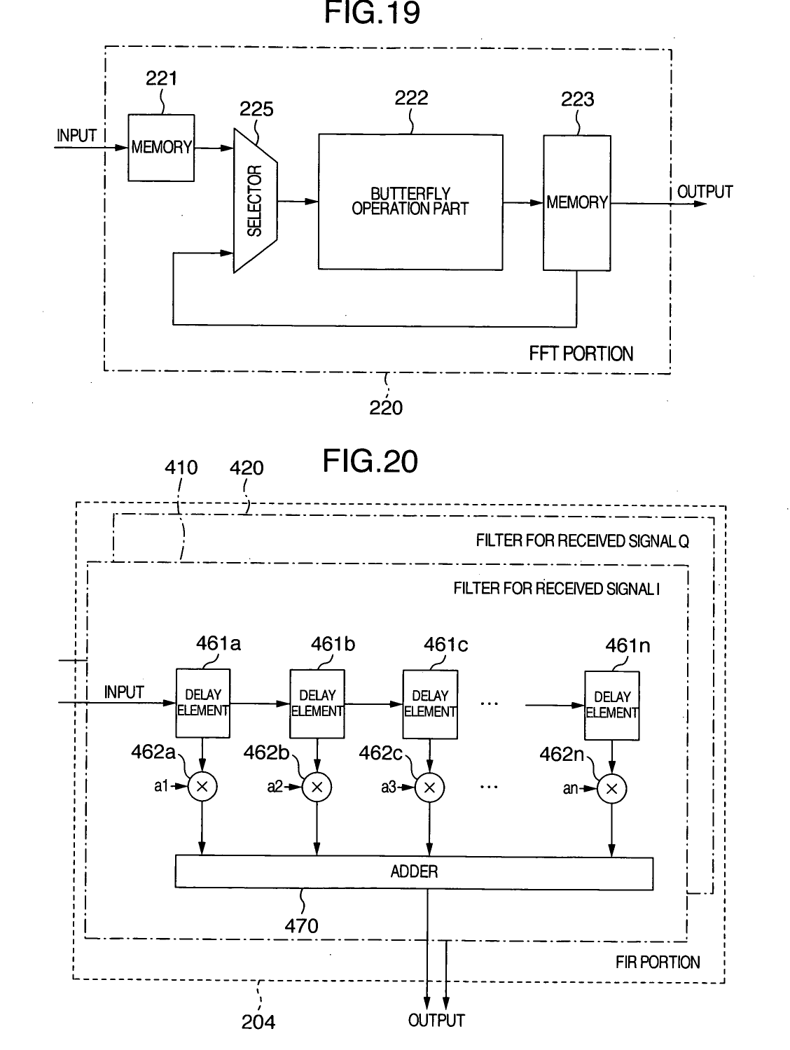

FIG. 17A is a timing chart of the process in the system using the FIR filter according this embodiment, and FIG. 17B is a timing chart of the process in the system using the FIR filter examined by the inventors before this invention.

In the system of this embodiment, since the FIR filter is operated in a small number of stages during the time from when the packet has been received to when the gain to AGC is set, the time required to coarsely set AGC is reduced as compared with the system using the FIR filter of many stages examined by the inventors before this invention. In addition, since the FIR filter is thereafter switched to the stage number to achieve the performance necessary for the normal operation, the short preamble, long preamble and data after the AGC setting are produced with the same delay. Therefore, the received signal with an appropriate level can be faster obtained. Moreover, since the short preamble of an appropriate level can be received for a longer time, the frequency error can be easily estimated by the self-correlation of the short preamble of 32-sample interval mentioned in the embodiment 2.

FIG. 18 shows an example of the construction of the whole wireless LAN system that uses the OFDM demodulator circuit according to the invention, and that is based on the IEEE802.11a standard. The signal received by an antenna 201a or 201b is supplied through a diversity/transmission-reception switch 601 to a band-pass filter 602 where the unnecessary waves are suppressed. The output signal from the filter is fed to an RF-IC 204. The RF-IC 204 converts the input signal to a base band signal, and amplifies the frequency-converted signal by use of an AGC circuit. The amplified received signal from the RF-IC 204 is supplied to a base band LSI 610 having the OFDM demodulator of the above embodiments and modulator circuit incorporated. In this base band LSI 610, an A/D converter 611 converts the input signal to a digital signal, and then a base band processor 612 demodulates the digital signal. The demodulated signal is fed to a medium access control (MAC) 613, where it is subjected to data access control according to a protocol. The signal from the MAC 613 is supplied through an I/O interface 614 to a high order layer so that data can be exchanged.

According to the above embodiments, since the average preamble is obtained by averaging the preamble on the time axis and then converting it to frequency axis information, it is possible to reduce the delay time from when the received packet is converted to the base band signal to when the demodulated signal is obtained with the transmission response corrected.

In addition, since the FIR filter is switched to a small stage number when the automatic gain control is performed at the packet receiving time, the time necessary for the automatic gain control to be completed can be reduced.

Also, since parts of the butterfly computation in the FFT processing are performed in parallel, the circuit scale can be suppressed from increasing, and the processing time can be reduced. As a result, the delay time taken until the demodulated data is produced from when the packet is received can be greatly decreased.

At the time of transmission, transmitted data is sent from the high-order layer through the I/O interface 614 to the access control 613 where it undergoes the data access control based on the protocol. The output from the access control 613 is supplied to the base band processor 612. The base band processor 612 modulates the transmitted signal to produce an OFDM modulated signal, which is then converted to an analog signal by a D/A converter 615. Then, the analog signal is supplied to, and converted by the RF-IC 204 to a signal of 5-GHz band. A transmitting band-pass filter 603 suppresses the unnecessary waves from the signal fed from the RF-IC 204, and then a power amplifier 604 amplifies the power of the transmitted signal up to desired signal intensity. The amplified signal is supplied through the diversity/transmission-reception switch 601 to the antenna 201a or 201b, from which it is transmitted.

While the invention made by the inventors has been described in detail on the basis of the embodiments, the present invention is not limited to the above embodiments, but can be of course variously changed without departing from the scope of the invention. For example, Radix2 may be used although Radix4 is used as butterfly computation in the above embodiments.

While this invention is applied to the OFDM demodulator circuit of the wireless LAN system according to the IEEE802.11a standard as a utilization field of the background of the invention, this invention is not limited to this system, but may be used for the demodulator circuit in the radio communications system using the OFDM modulation system and for the demodulator circuit in the broadcasting system.

It should be further understood by those skilled in the art that although the foregoing description has been made on embodiments of the invention, the invention is not limited thereto and various changes and modifications may be made without departing from the spirit of the invention and the scope of the appended claims.

1. A communication semiconductor integrated circuit having a demodulator circuit built in a single semiconductor chip, said demodulator circuit being used to demodulate a received OFDM-modulated packet signal including a preamble that has two or more successive fixed-signal sequences, said demodulator circuit comprising:
a frequency-error estimating/correcting function to estimate a frequency error of said received signal by use of said received preamble;
a fast Fourier transform function to convert said corrected received signal to a frequency-axis information signal from time-axis information;
a transmission path response estimating/correcting function to estimate the status of a transmission path from said converted signal and correct said received signal for said transmission path response; and
an averaging function to average said received signal after being corrected for said frequency error, said demodulator circuit being constructed so that said averaging process can be performed before said fast Fourier transform process.

2. A communication semiconductor integrated circuit according to claim 1, wherein said demodulator circuit further has delay means provided to delay said received preamble by a certain time so that said frequency-error estimating/correcting process is performed on the basis of said preamble delayed by said delay means and another preamble received after said delayed preamble.

3. A communication semiconductor integrated circuit according to claim 2, wherein said demodulator circuit further has second delay means provided to delay
said preamble after being corrected by said frequency-error estimating/correcting process, whereby
the successive preamble can be sequentially corrected by said frequency-error estimating/correcting function,
the corrected preamble can be delayed by said second delay means, said averaging process can be performed before said fast Fourier transform process by using said corrected and delayed preamble and said corrected preamble just produced from said frequency-error estimating/correcting process.

4. A communication semiconductor integrated circuit according to claim 1, wherein said demodulator circuit has a memory circuit for holding said received preamble so that said frequency-error estimating/correcting process can be performed on the basis of said preamble stored in said memory circuit and another preamble received after said stored preamble.

5. A communication semiconductor integrated circuit according to claim 1, wherein said packet is formed of said preamble, a signal and data, said signal includes information about a transfer rate and length of said data, and said averaging process is performed during the time in which said signal is being inputted.

6. A communication semiconductor integrated circuit according to claim 1, wherein said averaging process is performed by adding two preambles and then dividing said sum by 2.

7. A communication semiconductor integrated circuit according to claim 1, wherein said averaging process is performed by time-average of two successive preambles.

8. A communication semiconductor integrated circuit according to claim 1, wherein said demodulator circuit further comprises a finite impulse response type filter that has a plurality of delay stages connected in series to sequentially delay said received signal, and multipliers associated with said delay stages so as to remove out-of-band frequency components from said received signal, said finite impulse response type filter being constructed so that the number of said delay stages through which said received signal passes can be changed by switching.

9. A communication semiconductor integrated circuit according to claim 8, wherein said finite impulse response type filter further has a bypass through which said received signal can be transmitted without passing through any one or two or more of said delay stages, and selector means that selects either said received signal passed through said bypass or said received signal passed through said any one or two or more of said delay stages.

10. A communication semiconductor integrated circuit according to claim 1, wherein said fast Fourier transform function has first arithmetic operation means capable of complex multiplication of butterfly computation, a memory circuit for holding the result of computation by said first arithmetic operation means, and second arithmetic operation means capable of any stage computation of said fast Fourier transform process, said second arithmetic operation means making simpler computation than said first arithmetic operation means.

11. A communication semiconductor integrated circuit according to claim 10, wherein said first arithmetic operation means sequentially makes a first stage computation based on an input signal and a second stage computation based on said computed result held in said memory circuit, and said second arithmetic operation means makes a third stage computation at the same time that said first arithmetic operation means makes said second stage computation.

12. A communication semiconductor integrated circuit having a demodulator circuit built in a single semiconductor chip, said demodulator circuit being used to demodulate a received OFDM-modulated packet signal including a preamble that has two or more successive fixed-signal sequences, said demodulator circuit comprising:
a frequency-error estimating/correcting function to estimate a frequency error of said received signal by use of said received preamble;
a fast Fourier transform function to convert said corrected received signal to a frequency-axis information signal from time-axis information;
a transmission path response estimating/correcting function to estimate the status of a transmission path from said converted signal and correct said received signal for said transmission path response;
an averaging function to average said received signal after being corrected for said frequency error; and
a filter for removing out-of-band frequency components from said received signal,
said filter having a plurality of delay stages connected in series to sequentially delay said received signal, and multipliers associated with said delay stages so that the number of said delay stages through which said received signal passes can be changed by switching.

13. A communication semiconductor integrated circuit according to claim 12, wherein said filter has a bypass through which said received signal can be transmitted without passing through any one or two or more of said delay stages, and selector means that selects either said received signal passed through said bypass or said received signal passed through said any one or two or more of said delay stages.

14. A communication semiconductor integrated circuit according to claim 12, wherein said packet includes a first preamble having first fixed-signal sequences, and a second preamble having second fixed-signal sequences longer than said first fixed-signal sequences, said first preamble being continuously followed by said second preamble, and said filter is controlled so that the number of said delay stages through which said received signal passes can be reduced when said first preamble is processed.

15. A communication semiconductor integrated circuit having a demodulator circuit built in a single semiconductor chip, said demodulator circuit being used to demodulate a received OFDM-modulated packet signal including a preamble that has two or more successive fixed-signal sequences, said demodulator circuit comprising:
a frequency-error estimating/correcting function to estimate a frequency error of said received signal by use of said received preamble;
a fast Fourier transform function to convert said corrected received signal to a frequency-axis information signal from time-axis information;
a transmission path response estimating/correcting function to estimate the status of a transmission path from said converted signal and correct said received signal for said transmission path response; and
an averaging function to average said received signal after being corrected for said frequency error,
said fast Fourier transform function having first computation means capable of complex multiplication of butterfly computation, a memory circuit for holding the result of computation by said first computation means, and second computation means capable of any stage computation of said fast Fourier transform process,
said second computation means making simpler computation than said first computation means.

16. A communication semiconductor integrated circuit according to claim 15, wherein said first computation means is constructed to sequentially make a first stage computation based on an input signal and a second stage computation based on said computed result held in said memory circuit, and said second computation means is constructed to make a third stage computation at the same time that said first computation means makes said second stage computation.

17. A communication semiconductor integrated circuit having a single semiconductor chip comprising:
a demodulator circuit being constructed so that said averaging process can be performed before said fast Fourier transform process;
an A/D converter circuit for converting said received signal to a digital signal and supplying it to said demodulator circuit;
a modulator circuit for making OFDM modulation; and
a D/A converter circuit for converting said modulated signal from said modulator circuit to an analog signal, and producing it.

18. A radio communication system comprising:
a communication semiconductor integrated circuit having a demodulator circuit built in a single semiconductor chip, said demodulator circuit being used to demodulate a received OFDM-modulated packet signal including a preamble that has two or more successive fixed-signal sequences, said demodulator circuit comprising:
a frequency-error estimating/correcting function to estimate a frequency error of said received signal by use of said received preamble;
a fast Fourier transform function to convert said corrected received signal to a frequency-axis information signal from time-axis information;
a transmission path response estimating/correcting function to estimate the status of a transmission path from said converted signal and correct said received signal for said transmission path response; and
an averaging function to average said received signal after being corrected for said frequency error, said demodulator circuit being constructed so that said averaging process can be performed before said fast Fourier transform process; and
a high-frequency semiconductor integrated circuit having a frequency converter circuit for converting the frequency of a received signal to a base band signal, a variable gain amplifier circuit for amplifying said frequency-converted received signal to a predetermined level, and another frequency converter circuit for converting a transmitted signal to a high frequency signal,
said variable gain amplifier circuit having its amplification factor fixed on the basis of a gain setting signal supplied from said communication semiconductor integrated circuit.

19. A radio communication system according to claim 18, wherein
said high-frequency semiconductor integrated circuit has a received-intensity detector circuit that detects the intensity of said received signal on the basis of a preamble included in said received packet, and supplies said detected signal to the outside, and
said communication semiconductor integrated circuit has a gain setting circuit that determines the gain of said variable gain amplifier circuit on the basis of said detected signal from said received intensity detector circuit, and generates said gain setting signal to said variable gain amplifier circuit.

20. A radio communication system according to claim 19, wherein said gain setting circuit has a function to detect the intensity of said received signal on the basis of said received signal fed to said demodulator circuit, determine the gain of said variable gain amplifier circuit, and generate gain setting signals so that said gain setting circuit can generate a first gain setting signal to roughly fix the gain of said variable gain amplifier circuit on the basis of said detected signal produced from said received intensity detector circuit, and then generate a second gain setting signal to precisely fix the gain of said variable gain amplifier circuit on the basis of said received signal fed to said demodulator circuit.
